(19) United States
(12) Patent Application Publication
(10) Pub. No.: US 2012/0030585 A1
(43) Pub. Date: Feb. 2, 2012

(54) INFORMATION PROCESSING APPARATUS, METHOD OF CONTROLLING THE SAME AND STORAGE MEDIUM

(75) Inventor: Masao Akuzawa, Sagamihara-shi (JP)

(73) Assignee: CANON KABUSHIKI KAISHA, Tokyo (JP)

(21) Appl. No.: 13/060,478

(22) PCT Filed: Nov. 17, 2010
(86) PCT No.: PCT/JP10/70952

§ 371 Date: Feb. 24, 2011

(30) Foreign Application Priority Data
Dec. 14, 2009 (JP) 2009-283435

(51) Int. Cl. G06F 3/048; G06F 15/16

(52) U.S. Cl. 715/747

(57) ABSTRACT

This invention provides an information processing apparatus capable of, on an operation screen that can be customized in accordance with user's need, customizing the operation buttons of an application provided by an external apparatus, and a method of controlling the same. To accomplish this, an information processing system displays, on the operation screen of a Web application displayed on the information processing apparatus, a registration button to add, to a custom menu, custom buttons to be executed based on the current setting information of the currently running application. When the registration button is pressed, the information processing system manages button data and action data in association with each other as the information of custom buttons to be added to the custom menu. When the user instructs to display the custom menu, the information processing apparatus generates the custom menu including the custom buttons using the button data, and displays it.

### TECHNICAL FIELD

The present invention relates to an information processing system including a server apparatus and an information processing apparatus capable of using an external application provided by the server apparatus, the information processing apparatus, a method of controlling the same, and a storage medium.

### BACKGROUND ART

An information processing apparatus such as a PC is known to be connected to a Web server on a network and display an operation screen provided by the Web server on a Web browser installed in the information processing apparatus. In this case, the Web browser on the information processing apparatus requests the operation screen from the Web server, and a Web application on the Web server sends, to the information processing apparatus, an HTML file to display the operation screen on the Web browser in accordance with the request from the information processing apparatus. The Web browser on the information processing apparatus analyzes the received HTML file, and displays the operation screen based on the description of the HTML file as a Web browser screen. Additionally, when the user inputs an instruction via the operation screen displayed on the Web browser, the Web browser notifies the Web server of the input instruction. Upon receiving the notification, the Web application on the Web server executes processing in accordance with the input instruction.

Recently, some MFPs (Multi Function Peripherals) equipped with a scanner and a printer also include a Web browser as described above. The MFP displays, on its Web browser, an operation screen provided by a Web server in accordance with the above-described procedure, and receives various kinds of user instructions.

In Japanese Patent Laid-Open No. 2002-215573, a Web server distributes screen information including buttons to be used to select instruction contents to an information processing apparatus. More specifically, the user of the information processing apparatus selects a button on the screen displayed based on the distributed screen information, thereby displaying a Web browser screen or activating an application in accordance with instruction contents associated with the selected button. This allows the user to easily invoke frequently used functions by using the distributed buttons.

However, the above-described prior art has the following problems. For example, the contents of the buttons included in the distributed screen are limited to those registered by the administrator of the Web server in advance. In addition, the Web browser screen displayed upon selecting a button cannot display input items in which settings of, for example, an address, name, and number of copies are already input. Furthermore, control of unnecessary button deletion is not easy from the information processing apparatus serving as a client. That is, in the above-described prior art, the screen provided by the Web server can hardly display a screen customized in accordance with the demand of the user who uses the Web browser.

### SUMMARY OF INVENTION

The present invention enables realization of an information processing apparatus capable of customizing the operation buttons of an application provided by an external apparatus on an operation screen that can be customized in accordance with the user's demand, a method of controlling the same, and a storage medium.

One aspect of the present invention provides an information processing system including a server apparatus and an information processing apparatus capable of using an external application provided by the server apparatus, characterized in that the information processing apparatus comprises: first display control means for displaying, on a display unit, an operation screen of the external application including a registration button configured to register, in a custom menu, a custom button that causes a currently running application to execute processing based on current setting information; first notification means for, when the registration button is pressed, notifying the server apparatus of a registration request of action data concerning the current setting information together with the current setting information; button data storage means for, upon receiving a response to the registration request from the server apparatus, storing button data concerning the custom button using the action data added to the response; and second display control means for, upon receiving an instruction to display the custom menu, reading out the button data from the button data storage means, generating the custom menu including the custom button corresponding to the readout button data, and displaying the custom menu on the display unit, and the server apparatus comprises: action data storage means for, upon receiving the registration request of the action data, storing the received current setting information as the action data; and second notification means for notifying the information processing apparatus of a registration request of the button data together with the stored action data.

Another aspect of the present invention provides a method of controlling an information processing system including a server apparatus and an information processing apparatus capable of using an external application provided by the server apparatus, characterized in that the information processing apparatus executes: causing first display control means to display, on a display unit, an operation screen of the external application including a registration button configured to register, in a custom menu, a custom button that causes a currently running application to execute processing based on current setting information; causing first notification means to, when the registration button is pressed, notify the server apparatus of a registration request of action data concerning the current setting information together with the current setting information; causing button data storage means to, upon receiving a response to the registration request from the server apparatus, store button data concerning the custom button using the action data added to the response; and causing second display control means to, upon receiving an instruction to display the custom menu, read out the button data from the button data storage means, generate the custom menu including the custom button corresponding to the readout button data, and display the custom menu on the display unit, and the server apparatus executes: causing action data storage means to, upon receiving the registration request of the action data, store the received current setting information as the action data; and causing second notification means to notify the information processing apparatus of a registration request of the button data together with the stored action data.

Still another aspect of the present invention provides a computer-readable storage medium storing a computer program which causes a computer to execute the information processing apparatus control method.

Further features of the present invention will be apparent from the following description of exemplary embodiments with reference to the attached drawings.

### BRIEF DESCRIPTION OF DRAWINGS

FIG. 1 is a view showing the overall configuration of an information processing system 100 according to the first embodiment;

FIG. 2 is a block diagram showing an example of the arrangement of an MFP 101 according to the first embodiment;

FIG. 3 is a block diagram showing an example of the arrangement of a Web server 103 according to the first embodiment;

FIG. 4 is a block diagram showing an example of the control arrangement of the information processing system 100 according to the first embodiment;

FIG. 5 is a view showing examples of the data formats of button data 501 and action data 510 according to the first embodiment;

FIG. 6 is a view showing the user interface of a copy Web application according to the first embodiment;

FIG. 7 is a flowchart illustrating the procedure of button registration processing according to the first embodiment;

FIG. 8 is a view showing an operation screen 800 of a custom menu 470 according to the first embodiment;

FIG. 9 is a flowchart illustrating the procedure of button execution processing according to the first embodiment;

FIG. 10 is a view showing an operation screen 1000 of a custom menu 470 according to the second embodiment;

FIGS. 11A and 11B are flowcharts illustrating the procedure of button deletion processing according to the second embodiment;

FIG. 12 is a flowchart illustrating the procedure of button delete determination processing according to the second embodiment;

FIG. 13 is a view showing an example of button data 501 when a plurality of values are registered in an application ID 503 according to the third embodiment; and

FIG. 14 is a flowchart illustrating the procedure of causing a set operation screen request unit 483 according to the third embodiment to determine a Web server of obtaining destination.

### DESCRIPTION OF EMBODIMENTS

Embodiments of the present invention will now be described in detail with reference to the drawings. It should be noted that the relative arrangement of the components, the numerical expressions and numerical values set forth in these embodiments do not limit the scope of the present invention unless it is specifically stated otherwise.

### First Embodiment

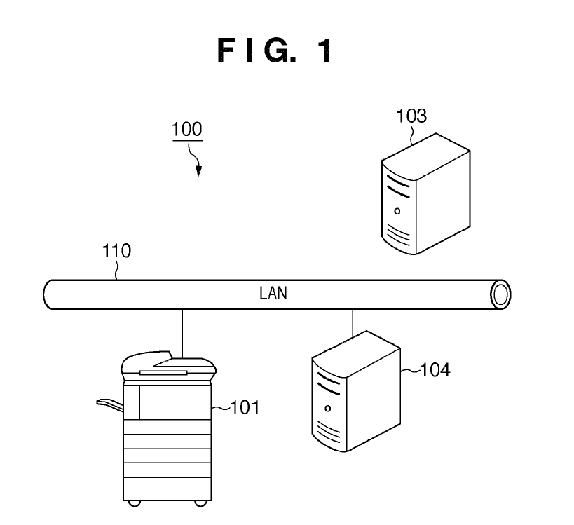

The first embodiment of the present invention will be described below with reference to FIGS. 1 to 9. In this embodiment, an MFP that is an example of an information processing apparatus requests an operation screen from a Web application using a Web browser. After that, the MFP registers, as buttons, the input values of the input items of the Web browser screen displayed on the provided operation screen.

<Configuration of Information Processing System>

The overall configuration of an information processing system 100 according to the embodiment will be described first with reference to FIG. 1. An MFP 101 and Web servers 103 and 104 are connected to a LAN 110 so as to be communicable with each other. An FTP (File Transfer Protocol) server (not shown) is also provided on the LAN 110 so that the MFP 101 can send image data to the FTP server by FTP. Note that FIG. 1 illustrates an example of the information processing system according to the embodiment so there is no intention to limit the types and number of apparatuses. Each of the Web servers 103 and 104 functions as a server apparatus that provides the screen information of a Web application to the MFP 101 serving as an information processing apparatus.

<Arrangement of MFP>

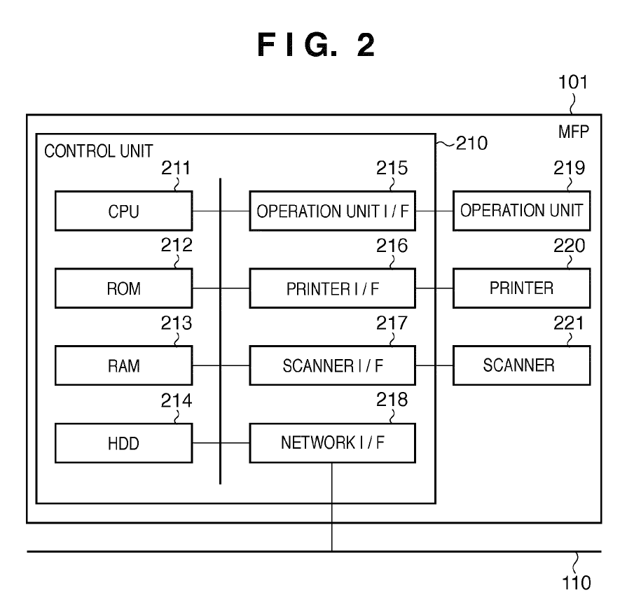

An example of the arrangement of the MFP 101 will be explained next with reference to FIG. 2. The MFP 101 includes a control unit 210, operation unit 219, printer 220, and scanner 221. The control unit 210 includes a CPU 211, ROM 212, RAM 213, HDD 214, operation unit I/F 215, printer I/F 216, scanner I/F 217, and network I/F 218.

The control unit 210 generally controls the operation of the MFP 101. The CPU 211 reads out control programs stored in the ROM 212, and executes various kinds of control processing such as read control and send control. The RAM 213 is used as a temporary storage area such as the main memory or work memory of the CPU 211. The HDD 214 stores image data, various programs, and various information tables to be described later.

The operation unit I/F 215 connects the operation unit (display unit) 219 to the control unit 210. The operation unit 219 includes a keyboard, a liquid crystal display unit having a touch panel function, and the like. The MFP 101 also has a Web browser function to be described later. The Web browser of the MFP 101 analyzes an HTML file (screen information) received from the Web server 103, and displays an operation screen based on the description of the received HTML file on the operation unit 219.

The printer I/F 216 connects the printer 220 to the control unit 210. Image data to be printed by the printer 220 is transferred from the control unit 210 to the printer 220 via the printer I/F 216, and the printer 220 prints it on a printing medium. The scanner I/F 217 connects the scanner 221 to the control unit 210. The scanner 221 reads an image on an original to generate image data, and inputs it to the control unit 210 via the scanner I/F 217. The network I/F 218 connects the control unit 210 (MFP 101) to the LAN 110. The network I/F 218 sends image data or information to an external apparatus (for example, Web server 103) on the LAN 110, or receives various kinds of information from the external apparatus on the LAN 110.

<Arrangement of Web Server>

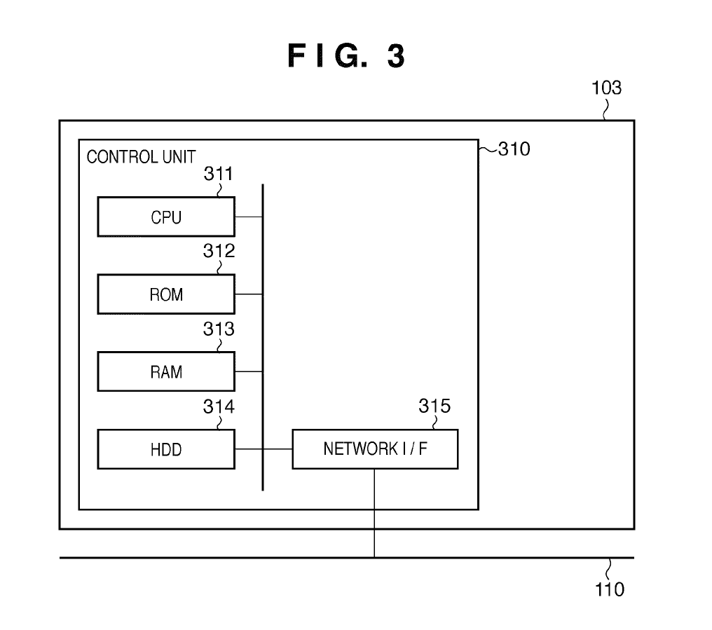

An example of the arrangement of the Web server 103 will be described next with reference to FIG. 3. Note that the Web server 104 has the same arrangement as that of the Web server 103, and a description thereof will be omitted. The Web server 103 includes a control unit 310. The control unit 310 includes a CPU 311, ROM 312, RAM 313, HDD 314, and network I/F 315.

The control unit 310 generally controls the operation of the Web server 103. The CPU 311 reads out control programs stored in the ROM 312, and executes various kinds of control processing. The RAM 313 is used as a temporary storage area such as the main memory or work area of the CPU 311. The HDD 314 stores image data, various programs, and various information tables to be described later. The network I/F 315 connects the control unit 310 (Web server 103) to the LAN 110. The network I/F 315 sends/receives various kinds of information to/from another apparatus on the LAN 110.

<Control Arrangement of Information Processing System>

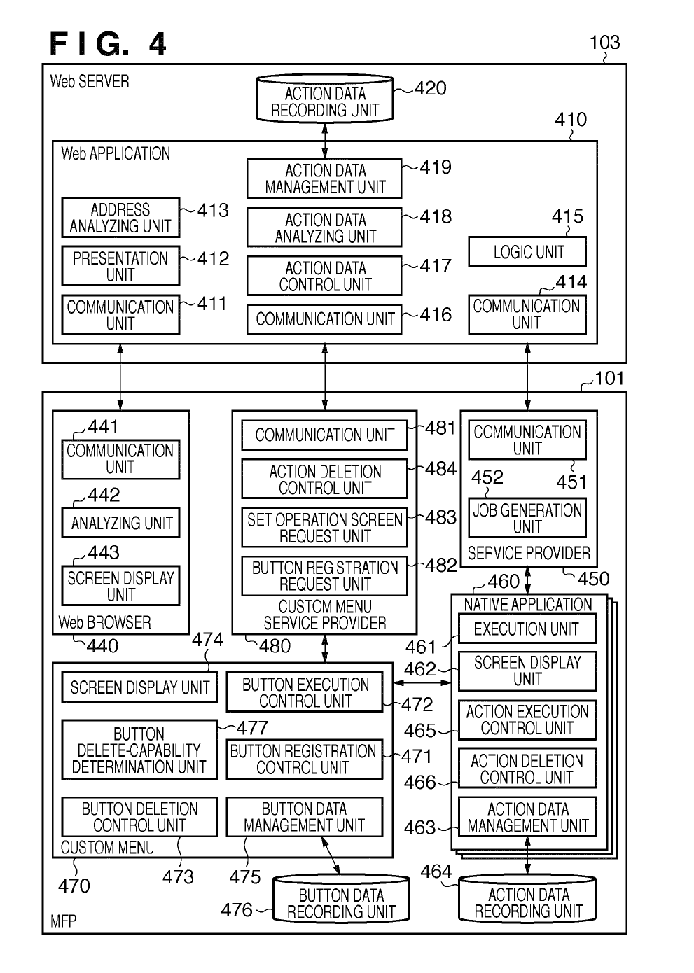

An example of the control arrangement of the entire information processing system 100 will be described next with reference to FIG. 4. The functional units shown in FIG. 4 are implemented by causing the CPUs 211 and 311 provided in the MFP 101 and the Web server 103, respectively, to execute control programs. The MFP 101 includes a Web browser 440, service provider 450, native applications 460, custom menu 470, custom menu service provider (CMSP) 480, action data-recording unit 464, and button data-recording unit 476. The Web server 103 includes a Web application 410.

Each native application 460 includes an execution unit 461, screen display unit 462, action data management unit 463, action execution control unit 465, and action deletion control unit 466. Examples of the native applications 460 are a copy application, scan application, and send application that execute copy processing, scan processing, and scan image distribution processing. In the present invention, however, the native applications 460 need only be applications usable in the MFP 101 so there is no intention to limit them to the above-described application software. For example, the Web browser 440 to be described later is one of native applications. Such applications provided in the MFP 101 in advance will be referred to as native applications hereinafter. On the other hand, applications provided by the Web server 103 will be referred to as Web applications.

The execution unit 461 executes main processing of the application. In the above-described examples, execution targets are copy processing, scan processing, and send processing. The screen display unit 462 displays, on the operation unit 219, an operation screen that causes the user to input settings necessary for execution of the execution unit 461. Note that the operation screen is not provided by the Web server 103 but displayed based on information held in the MFP 101 and read out by the native application 460. The screen displayed based on information held in the MFP 101 in advance will be referred to as a native screen hereinafter.

The action data management unit 463 exchanges action data with the action data-recording unit 464. Although details will be described later, action data is individual setting information of each application. In, for example, a copy application, action data represents setting information such as the number of copies and print density. Note that data handled by the action data-recording unit 464 is stored in, for example, the HDD 214. The action execution control unit 465 reads action data received from the action data management unit 463, generates a set operation screen in which each setting item is already set, and provides it to the screen display unit 462. The action deletion control unit 466 requires the action data management unit 463 to delete target action data, and receives a deletion result.

The custom menu 470 includes a button registration control unit 471, button execution control unit 472, button deletion control unit 473, screen display unit 474, button data management unit 475, and button delete-capability determination unit 477. The custom menu 470 implements a mechanism for registering a set value of various kinds of applications usable in the MFP 101 in association with one button, thereby constructing an operation screen desired by the user. This embodiment copes with, as the various applications usable in the MFP 101, not only the conventional native applications but also the Web application.

The native application 460 and the CMSP 480 invokes the button registration control unit 471. At this time, the button registration control unit 471 sends a button data registration request to the button data management unit 475, and receives a button registration result. Although details will be described later, button data includes a number to identify a button, an application corresponding to the button, an action ID representing the number of action data, an icon representing the outer appearance of the button, group information, and a button name.

The button execution control unit 472 notifies the native application 460 corresponding to the selection target button or the CMSP 480 of the action IC included in the button data. The button deletion control unit 473 obtains button data from the button data management unit 475. The button deletion control unit 473 then requests the native application 460 or the CMSP 480 to delete corresponding action data, and receives the action data deletion result. If deletion has succeeded, the button deletion control unit 473 requests the button data management unit 475 to delete corresponding button data.

The screen display unit 474 displays, on the operation unit 219, an operation screen to be used by the user to execute a registered button or delete button data. The button data management unit 475 exchanges (registers and deletes) button data with the button data-recording unit 476. The button delete-capability determination unit 477 determines in advance whether button data is deletable for button data deletion by the button deletion control unit 473. Note that the custom menu 470 need not always include all the above-described constituent elements.

The Web browser 440 includes a communication unit 441, analyzing unit 442, and screen display unit 443. The communication unit 441 communicates with a presentation unit 412 of the Web application 410 via a communication unit 411 of the Web application 410 in accordance with the HTTP protocol. More specifically, the communication unit 441 requests an operation screen to be displayed on the Web browser 440 from the Web application 410, or notifies the Web application 410 of a user instruction input via the operation screen displayed on the Web browser.

The analyzing unit 442 analyzes an HTML file received from the Web application 410. The HTML file includes a description representing the contents of an operation screen to be displayed on the Web browser. The screen display unit 443 displays an operation screen on the operation unit 219 based on the analysis result of the analyzing unit 442. A screen thus displayed based on screen information (HTML file) received from the Web server will be referred to as a Web browser screen.

On the other hand, the Web server 103 includes the Web application 410 and an action data-recording unit 420. The Web application 410 includes communication units 411, 414, and 416, presentation unit 412, address analyzing unit 413, logic unit 415, action data control unit 417, action data analyzing unit 418, and action data management unit 419. The presentation unit 412 communicates with the communication unit 441 of the Web browser 440 via the communication unit 411 so as to send an operation screen to be displayed on the Web browser 440 to the MFP 101 in accordance with a request from the MFP 101. The presentation unit 412 also receives, from the MFP 101, a user instruction input via the operation screen displayed on the Web browser 440.

Upon receiving an instruction from the MFP 101, the Web application 410 executes various kinds of processing in accordance with the contents of the instruction, and requests the MFP 101 to execute processing. More specifically, the Web application 410 requests execution of print processing by the printer 220 of the MFP 101, execution of read processing by the scanner 221, or execution of send processing via the network I/F 218. To request the MFP 101 to execute processing, the logic unit 415 communicates with a communication unit 451 in the service provider 450 provided in the MFP 101 via the communication unit 414. The service provider 450 includes the communication unit 451 and a job generation unit 452. The communication unit 451 receives, via the communication unit 414, a processing request generated by the logic unit 415. The job generation unit 452 generates a job from information received by the communication unit 451, and outputs it to the native application 460.

The action data control unit 417 receives, via the communication unit 411, a registration instruction from the user via the operation screen displayed on the Web browser. The action data control unit 417 also executes button data registration request processing, set operation screen generation processing, and action data deletion processing with the CMSP 480 via the communication unit 416. The action data analyzing unit 418 analyzes the contents of the registration instruction from the user, and creates action data. The action data management unit 419 exchanges action data with the action data-recording unit 420. Note that the data to be handled by the action data-recording unit 420 is stored in the HDD 314. The address analyzing unit 413 determines, upon receiving an operation screen request from the MFP 101, whether the address includes action data, and requests the action data control unit 417 to execute action data embedding processing.

The CMSP 480 includes a communication unit 481, button registration request unit 482, set operation screen request unit 483, and action deletion control unit 484. After action data registration is completed, the button registration request unit 482 receives a button data registration request from the action data control unit 417 via the communication units 416 and 481. After that, the button registration request unit 482 notifies the custom menu 470 of the button data registration request. The set operation screen request unit 483 receives a button press notification from the custom menu 470. At this time, the set operation screen request unit 483 obtains the application ID and action ID (to be described later) of the target button data. Then, the set operation screen request unit 483 creates an address by combining the application ID and action ID, and requests a set operation screen from the Web application 410 via the communication units 481 and 411. The action deletion control unit 484 receives a deletion request of action data of the Web application from the custom menu 470. At this time, the action deletion control unit 484 obtains the application ID and action ID of the target button data. Then, the action deletion control unit 484 requests the Web application 410 to delete the target action data. The action deletion control unit 484 also returns the action data deletion result from the Web application 410 to the custom menu 470.

As described above, the MFP 101 according to the embodiment can execute the Web application (external application) to be executed using information obtained from the Web server 103 serving as an external apparatus, and a native application to be executed using information held in advance. The MFP 101 has a custom menu function of allowing the user to construct a desired menu screen. The custom menu according to the embodiment can selectively display shortcut keys of the above-described Web application and native application.

<Data Format>

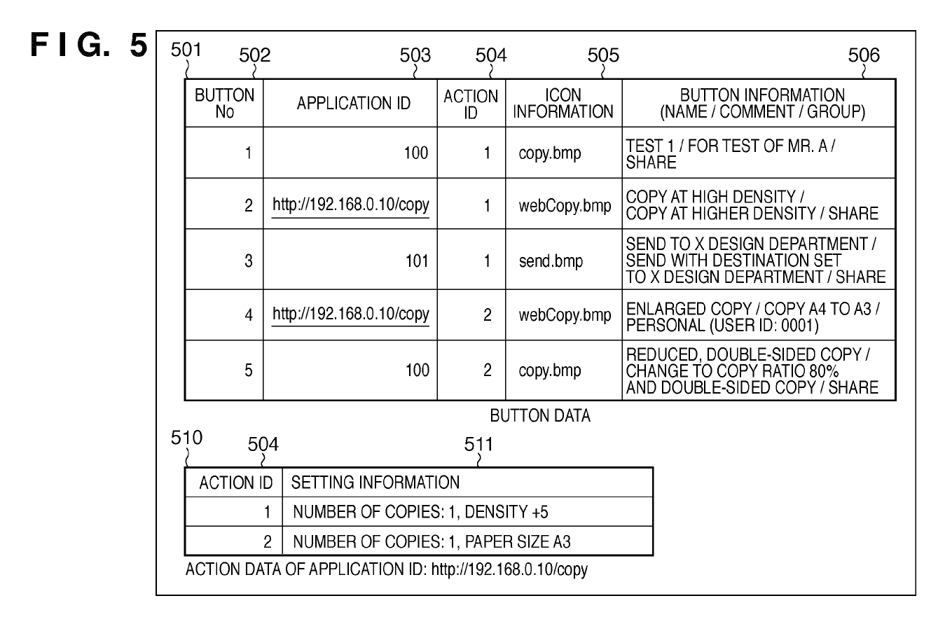

Examples of the data formats of button data 501 and action data 510 will be described next with reference to FIG. 5. The button data 501 includes a button No 502, application ID 503, action ID 504, icon information 505, and button information 506. Note that the button data 501 is managed by the custom menu 470.

The button No 502 is a number that uniquely identifies the button data 501 and is automatically assigned by the custom menu 470 upon button registration. The application ID 503 is a number that uniquely identifies the application. The application ID 503 is uniquely assigned by the custom menu 470 for each of the native applications 460 and the Web applications at the time of application installation. Note that for a Web application, the address where the Web application operates may be registered as the ID, as shown in FIG. 5. For example, an application whose application ID 503 is “100” is a copy application that is a native application. An application whose application ID 503 is “http://192.168.0.10/copy” is a copy Web application that is a Web application. Note that for a Web application, a Web browser may be registered in the application ID 503 by operating from the browser. In this case, the browser manages the URL of the Web application.

The icon information 505 represents an icon file name representing the outer appearance of the button displayed on the operation unit 219 via the screen display unit 474 of the custom menu 470. The button information 506 represents the button name, comment, and group. Note that the groups are roughly classified into my button as a personal button and a group button commonly usable among users.

The action data 510 includes setting information 511 together with the above-described action ID 504. Note that the action data 510 is managed for each application. The action ID 504 is a number that uniquely identifies action data and is assigned by each application. The setting information 511 includes various set values for each application. For example, setting information corresponding to the application ID 503 “http://192.168.0.10/copy” and the action ID 504 “1” represents contents including, as set values, number of copies “1” and density “+5”, as shown in FIG. 5. In this way, the button data 501 and the action data 510 are associated with each other via the action ID 504. For example, upon detecting press of the button corresponding to the button No 502 “2”, the custom menu 470 requests an operation screen in which the contents (number of copies “1” and density “+5”) corresponding to the action ID 504 “1” are set from the Web application, and displays it on the operation unit 219.

As described above, in this embodiment, not only the buttons of native applications but also the buttons of Web applications can be registered on an operation screen in the custom menu screen. This allows the user to easily construct a desired custom menu screen without concern for whether the application to be registered in the custom menu screen is a native application or Web application.

<Example of Screen>

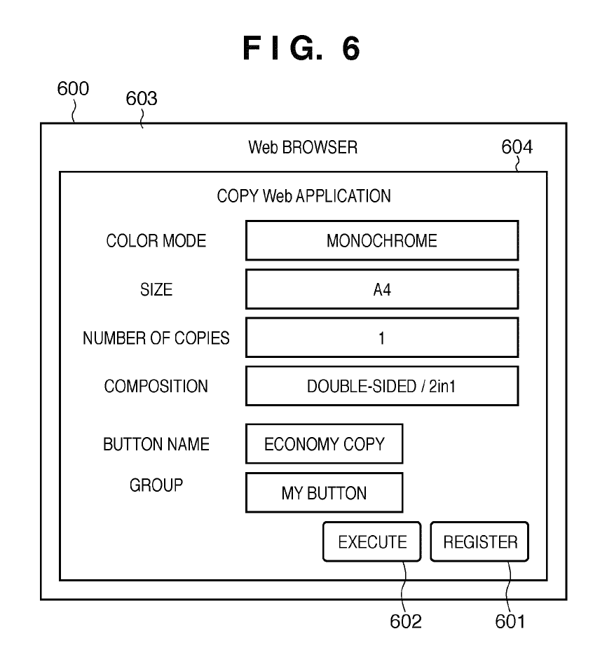

An example of a Web browser screen 600 displayed on the operation unit 219 will be described here with reference to FIG. 6. The Web browser screen 600 shown in FIG. 6 includes an operation screen 604 of a copy Web application and an operation screen 603 displayed by the Web browser 440. The operation screen 604 of the copy Web application includes an execution button 602 and a registration button 601 in addition to setting items (color mode, size, number of copies, composition, button name, and group). As shown in FIG. 6, in the Web browser screen 600, the operation screen 604 provided by the Web application 410 of the Web server 103 is displayed on the operation screen 603 provided by the Web browser 440. In the following description, the Web browser 440 functions as a first display control means.

The registration button 601 is a button to be used to register the currently running Web application on the custom menu screen, and is provided by the Web application 410. The execution button 602 is used to execute processing of the currently running Web application, and is provided by the Web application 410. When the registration button 601 is pressed, the information currently set on the operation screen 604 is read out. Buttons (custom buttons) to perform the same operation as that performed by pressing the execution button 602 of the setting information are generated and registered on the custom menu screen. According to the embodiment, it is possible to add custom buttons to execute a Web application to the custom menu screen by displaying the above-described Web browser screen 600.

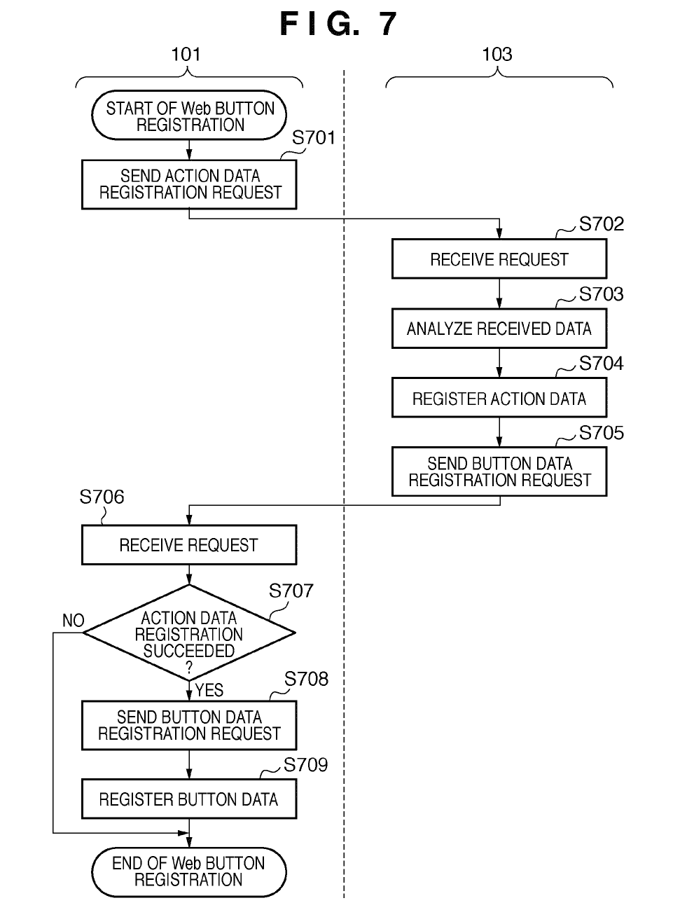

Note that although an arrangement for adding the registration button 601 to the operation screen 604 of a Web application has been described here, the registration button may be displayed on the operation screen of a native application, as a matter of course. In this case as well, when the registration button is pressed, the custom buttons of the native application are added to the custom menu, as in processing to be described with reference to FIG. 7.

<Registration Procedure>

The procedure of processing of registering buttons for a Web application from the Web browser 440 of the information processing system 100 according to the embodiment will be described next with reference to FIG. 7. The processing to be explained below is implemented by causing the CPUs 211 and 311 of the MFP 101 and the Web server 103 to read out programs stored in the ROMs 212 and 312 or the HDDs 214 and 314 to the RAMS 213 and 313 and execute the programs. Note that in FIG. 7, the left side of the dotted line indicates processing of the MFP 101, and the right side of the dotted line indicates processing of the Web server 103. The following processing procedure starts from a state in which the screen display unit 443 displays the Web browser screen 600 on the operation unit 219.

In step S701, the Web browser 440 functions as a first notification means. Upon detecting press of the registration button 601 on the Web browser screen 600, the Web browser 440 starts button registration processing, and requests the Web application 410 to register action data. More specifically, the Web browser 440 notifies the Web application 410 of each set value the user has input to the Web browser screen 600 (more specifically, to the operation screen 604 on the Web browser screen 600).

In step S702, the Web application 410 receives the registration request via the communication unit 411. In step S703, the action data control unit 417 starts action data registration processing, and requests the action data analyzing unit 418 to analyze the received data. The action data analyzing unit 418 converts the received data into data, that is, the action data 510 processable by the action data management unit 419, and returns it to the action data control unit 417.

In step S704, the action data control unit 417 transfers the action data 510 to the action data management unit 419, and requests registration. The action data management unit 419 functions as an action data storage means so as to assign a unique action ID to the action data 510, and register the action data 510 in the action data-recording unit 420. When registration of the action data 510 is completed, the action data control unit 417 functions as a second notification means so as to notify the CMSP 480 of a registration request of corresponding button data via the communication units 416 and 481 in step S705. At this time, the action data control unit 417 adds the URL, action ID, icon, action data, button name, and group of the Web application 410 to the registration request. Information about success/failure of registration is also added to the registration request.

In step S706, the CMSP 480 receives the registration request sent in step S705 as the response to the request in step S701. In step S707, the button registration request unit 482 analyzes the information added to the registration request, and determines whether action data registration has succeeded. In case of failure of action data registration, the button registration request unit 482 determines that registration has failed, and ends the processing without registering button data. On the other hand, if action data registration has succeeded, the process advances to step S708. The button registration request unit 482 notifies the custom menu 470 of the button data registration request together with the URL, action ID, icon, button name, and group added to the registration request.

In step S709, the button registration control unit 471 of the custom menu 470 functions as a button data storage means so as to send the registration request to the button data management unit 475 together with the received registration data. The button data management unit 475 creates button data from the registration data, assigns a button No, registers the button data in the button data-recording unit 476, and ends the processing. The series of processes of registering the button for the Web application in the custom menu thus ends.

<Execution Procedure>

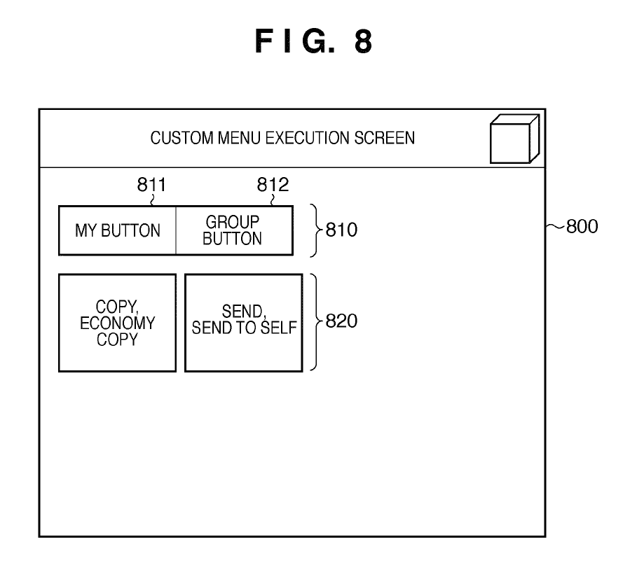

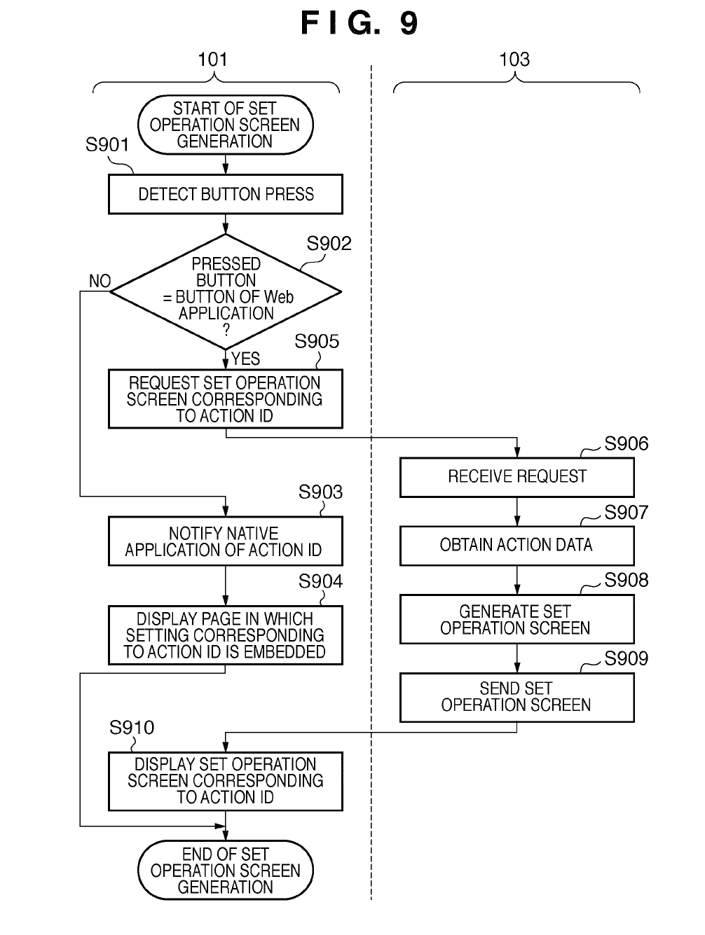

Processing to be executed when a registered button is selected from an operation screen (custom menu screen) 800 of the custom menu 470 in the MFP 101 will be described next with reference to FIGS. 8 and 9. First, an example of the operation screen 800 displayed on the operation unit 219 to execute a registered button of the custom menu 470 will be explained with reference to FIG. 8. The operation screen 800 of the custom menu 470 includes a group selection portion 810 and a button selection portion 820. The group selection portion 810 is an interface to select the type of buttons to be displayed on the operation screen 800. Note that in this embodiment, the button types selectable by the group selection portion 810 are a my button 811 and a group button 812. However, it is not intended here to limit the groups to these two types. The button selection portion 820 shown in FIG. 8 indicates a state in which the my button 811 is selected. The button selection portion 820 displays registered buttons for each group type. In this embodiment, for example, an economy copy button and a send-to-self button registered by the processing described with reference to FIG. 7 are displayed.

The procedure of processing to be executed upon detecting press of a button on the operation screen 800 will be described next with reference to FIG. 9. The processing to be explained below is implemented by causing the CPUs 211 and 311 of the MFP 101 and the Web server 103 to read out programs stored in the ROMs 212 and 312 or the HDDs 214 and 314 to the RAMs 213 and 313 and execute the programs. Note that in FIG. 9, the left side of the dotted line indicates processing of the MFP 101, and the right side of the dotted line indicates processing of the Web server 103. The following processing procedure starts from a state in which activation processing of the custom menu 470 interrupts the CPU 211 upon pressing the custom menu screen activation button displayed on the operation unit 219 so that the screen display unit 474 displays the operation screen 800 on the operation unit 219. The screen display unit 474 functions as a second display control means.

In step S901, the operation unit 219 detects the user pressing a button registered on the custom menu screen, and notifies the CPU 211 of the button press. The CPU 211 notifies the custom menu 470 of the button press. The custom menu 470 invokes interrupt processing corresponding to the button press.

In step S902, the custom menu 470 determines whether the application corresponding to the pressed button is a native application or a Web application. More specifically, the custom menu 470 obtains the button data 501 of the pressed button from the button data management unit 475, and confirms the application ID 503 of the obtained button data 501. If a URL is described in the application ID 503, the application is determined as a Web application, and otherwise, as a native application. If the application ID 503 corresponding to the pressed button indicates a native application, the process advances to step S903. If it indicates a Web application, the process advances to step S905.

In step S903, the custom menu 470 notifies the native application of the action ID 504 of the button data 501 obtained by the button execution control unit 472. In step S904, the action execution control unit 465 of the native application 460 obtains the action data 510 corresponding to the action ID 504 from the action data management unit 463. The action execution control unit 465 sets each setting item of the operation screen based on the setting information 511 of the obtained action data 510. The screen display unit 462 then displays the set operation screen generated by the action execution control unit 465 on the operation unit 219, and ends the processing. The processing to be executed when the button of a native application is pressed on the custom menu has been described above.

On the other hand, upon determining in step S902 that the pressed button is the button of a Web application, the button execution control unit 472 requests the CMSP 480 to display a set operation screen in step S905. At this time, the button execution control unit 472 adds the application ID 503 and the action ID 504 to the request. Upon receiving the request, the set operation screen request unit 483 of the CMSP 480 notifies the Web server 103 of the set operation screen request via the communication unit 481. In this case, the button execution control unit 472 and the CMSP 480 function as a request means.

In step S906, the action data control unit 417 of the Web application 410 receives the set operation screen request via the communication unit 416. At this time, the address analyzing unit 413 analyzes the set operation screen request, and separates the added action ID 504 and application ID 503. In step S907, the action data control unit 417 obtains, from the action data management unit 419, the action data 510 corresponding to the action ID 504 added to the request. In step S908, the action data control unit 417 sets each setting item of the operation screen to be sent to the MFP 101 based on the obtained action data 510. More specifically, the action data control unit 417 generates an HTML file that validates attributes representing selection of tags each having a list box or radio button input function and a value attribute corresponding to each setting information 511 of the action data 510. For example, for a list box, the selected attribute of the option tag is designated. For a radio button, the checked attribute of the input tag is designated.

In step S909, the presentation unit 412 sends, to the MFP 101 via the communication unit 411, the generated operation screen to be displayed on the Web browser. That is, the process in steps S908 and S909 is an example of a sending means. In step S910, the Web browser 440 receives the HTML file from the Web application 410 via the communication unit 441. The screen display unit 443 displays the set operation screen on the operation unit 219 based on the HTML file analysis result of the analyzing unit 442. The processing to be executed when the button of a Web application is pressed on the custom menu has been described above.

As described above, the information processing system according to the embodiment displays, on the operation screen of a Web application or native application, the registration button to add, to the custom menu, custom buttons to be executed based on the current setting information of the currently running application. When the registration button is pressed, the information processing system manages button data and action data in association with each other as the information of custom buttons to be added to the custom menu. More specifically, when the registration button of a Web application is pressed, the server apparatus manages action data, and the information processing apparatus manages button data in association with the action data. When the user instructs to display the custom menu, the information processing apparatus generates the custom menu including the custom buttons using the button data, and displays it. When the user presses an arbitrary custom button of the custom menu, the information processing apparatus displays an operation screen following the setting information upon registering the custom button using the button data and action data. For example, when a custom button concerning a Web application is pressed, the information processing apparatus obtains action data from the server apparatus. That is, the information processing system according to the embodiment can register not only shortcut keys of native applications but also those of Web applications on a custom menu that allows the user to construct a desired menu. Hence, the information processing apparatus can provide a user-friendly operation system because the user can construct a custom menu without being conscious of native applications and Web applications.

### Second Embodiment

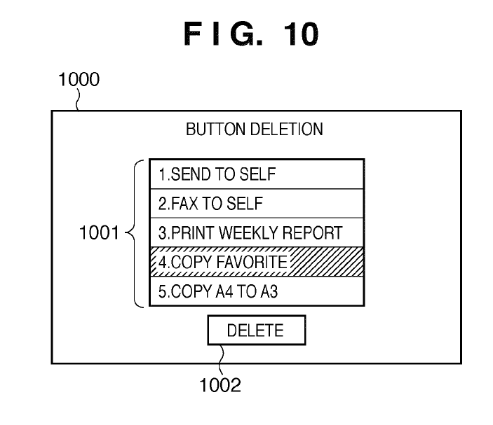

The second embodiment of the present invention will be described below with reference to FIGS. 10 to 12. In this embodiment, a series of processes of deleting a registered button from the operation screen of a custom menu 470 of an MFP 101 will be explained. Note that the overall arrangement of an information processing system 100 according to the embodiment, the arrangement of the MFP 101, the arrangement of a Web server 103, the control arrangement of the entire information processing system 100, the structure of button data 501, and the structure of action data 510 are the same as in the first embodiment, and a description thereof will not be repeated.

An example of an operation screen 1000 displayed on an operation unit 219 to delete a registered button from a custom menu screen will be described first with reference to FIG. 10. The operation screen 1000 includes a deletion button selection portion 1001 and a button deletion button 1002. The deletion button selection portion 1001 is an interface to select a button to be deleted. In FIG. 10, the “4. copy favorite” button is selected. Upon detecting press of the button deletion button 1002, the custom menu 470 invokes processing of deleting the button selected in the deletion button selection portion 1001. Note that the operation screen 1000 is displayed on the operation unit 219 by a screen display unit 474 serving as a third display control means.

<Deletion Procedure>

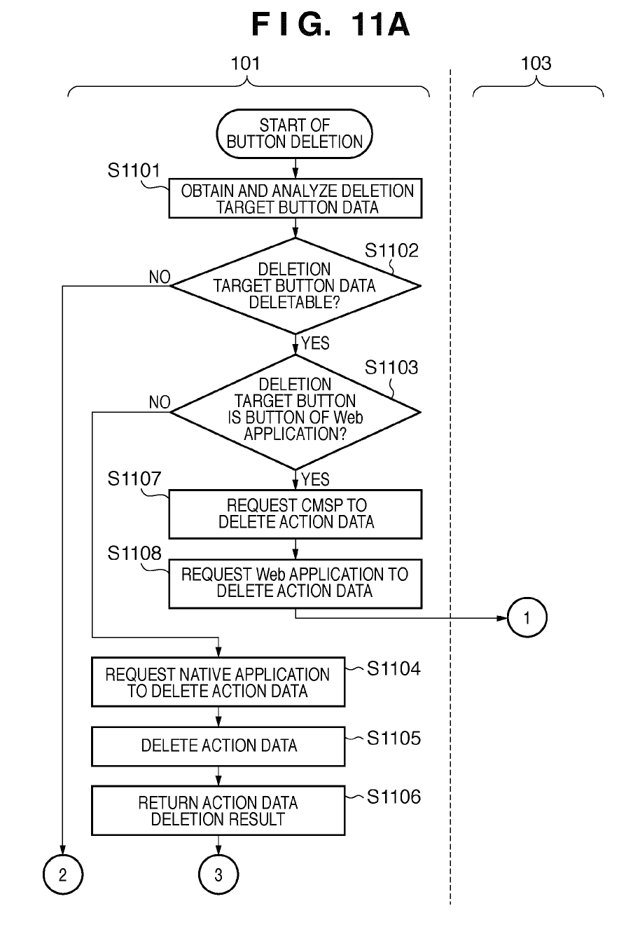

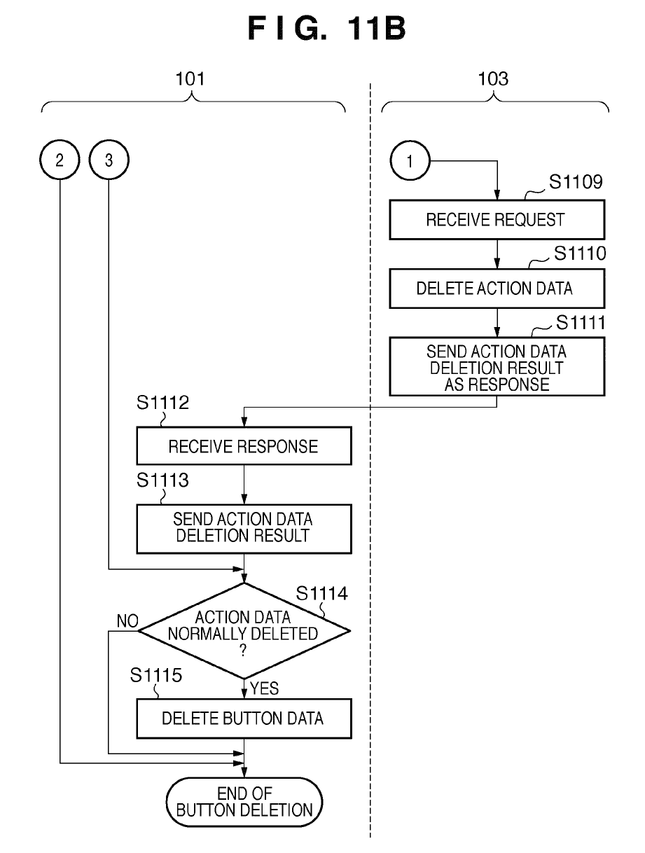

The procedure of processing of deleting a registered button via the operation screen 1000 for button deletion of the custom menu 470 according to the embodiment will be described next with reference to FIGS. 11A and 11B. The processing to be explained below is implemented by causing CPUs 211 and 311 of the MFP 101 and the Web server 103 to read out programs stored in ROMs 212 and 312 or HDDs 214 and 314 to RAMs 213 and 313 and execute the programs. Note that in FIG. 9, the left side of the dotted line indicates processing of the MFP 101, and the right side of the dotted line indicates processing of the Web server 103. The following processing procedure starts from a state in which the CPU 211 detects press of the button deletion button 1002 of the operation screen 1000 displayed on the operation unit 219 by the screen display unit 474, and notifies the custom menu 470 of the press of the button deletion button 1002.

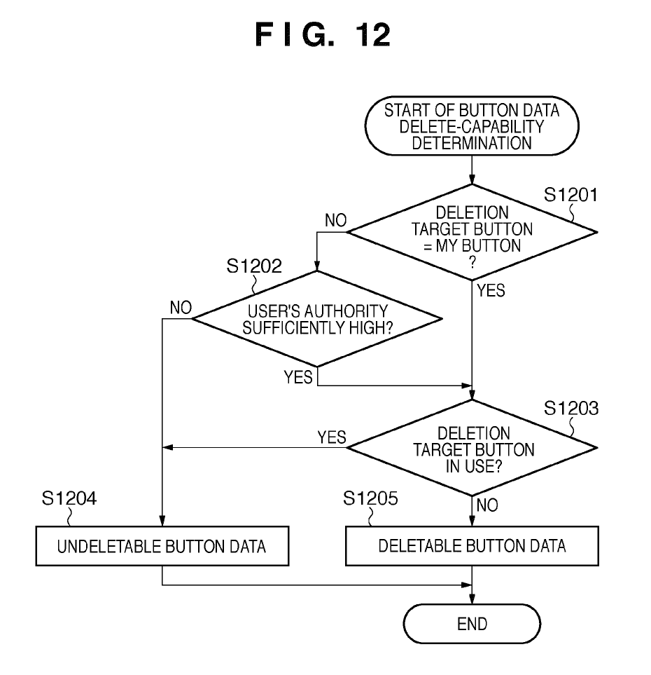

In step S1101, a button deletion control unit 473 of the custom menu 470 obtains the corresponding button data 501 from a button data management unit 475 in accordance with press of the button deletion button 1002, and analyzes the obtained button data 501. In step S1102, the button deletion control unit 473 inquires of a button delete-capability determination unit 477 to determine whether the obtained button data 501 is deletable. Processing of the button delete-capability determination unit 477 will be described later with reference to FIG. 12. If the button data is deletable, the process advances to step S1103. Otherwise, the processing ends.

In step S1103, the button deletion control unit 473 extracts a corresponding application ID 503 from the analyzed button data 501, and determines whether the corresponding application is a Web application or a native application. If it is a native application, the process advances to step S1104. If it is a Web application, the process advances to step S1107. Note that if a URL is described in the application ID 503, the button deletion control unit 473 determines the application as a Web application, and otherwise, as a native application.

In step S1104, the button deletion control unit 473 requests the native application corresponding to the application ID 503 to delete the action data 510. At this time, the button deletion control unit 473 adds an action ID 504 of the action data 510 to be deleted to the request. In step S1105, an action deletion control unit 466 receives the request, and requests an action data management unit 463 to delete the action data 510 based on the action ID 504 added to the request. The action data management unit 463 receives the request, and deletes the action data from an action data-recording unit 464. In step S1106, the action deletion control unit 466 obtains the deletion result (success or failure) from the action data management unit 463, and returns the deletion result to the custom menu 470.

On the other hand, if the deletion target button is a button of a Web application, the button deletion control unit 473 requests a CMSP 480 to delete the action data while adding the application ID 503 and the action ID 504 in step S1107. In step S1108, an action deletion control unit 484 receives the request, and determines the Web application having the action data 510 of the deletion target based on the application ID 503. The action deletion control unit 484 functions as a third notification means so as to notify a determined Web application 410 of the action data deletion request via a communication unit 481 together with the action ID 504.

In step S1109, an action data control unit 417 of the Web application 410 receives the deletion request via a communication unit 416. In step S1110, the action data control unit 417 requests an action data management unit 419 to delete the action data 510 corresponding to the action ID 504. Upon receiving the request, the action data management unit 419 functions as a second deletion means so as to delete the corresponding action data 510 from an action data-recording unit 420, and return the deletion result (success or failure) to the action data control unit 417. In step S1111, the action data control unit 417 functions as a fourth notification means so as to return the action data deletion result to the CMSP 480 via the communication unit 416 as a response.

In step S1112, the action deletion control unit 484 receives, via the communication unit 481, the response sent in step S1111. In step S1113, the action deletion control unit 484 returns the deletion result of the action data 510 to the custom menu 470. In step S1114, the button deletion control unit 473 analyzes the deletion result of the action data 510. If deletion of the action data 510 has normally been done, the process advances to step S1115. If deletion has failed, the button deletion processing ends without deleting the corresponding button data 501. In step S1115, the button deletion control unit 473 functions as a first deletion means so as to delete the button data. More specifically, the button deletion control unit 473 requests the button data management unit 475 to delete the target button data 501. Upon receiving the request, the button data management unit 475 deletes the button data from a button data-recording unit 476. The processing of deleting a button registered in the custom menu 470 has been described above.

The procedure of processing of determining the delete-capability of the button data 501 in step S1102 will be described next with reference to FIG. 12. As described above, in step S1102, the button deletion control unit 473 inquires of the button delete-capability determination unit 477 about whether the button data 501 is deletable. Processing of the button delete-capability determination unit 477 corresponding to the inquiry in step S1102 will be described below.

In step S1201, the button delete-capability determination unit 477 confirms the group of the button data 501 of the deletion target. If the group is a my button 811, the process advances to step S1203. If the group is a group button 812, the process advances to step S1202. In step S1202, the button delete-capability determination unit 477 confirms whether the user who requests deletion has a sufficiently high access right to the permission of the deletion target button. More specifically, for example, if the user is the administration user of the MFP 101, the group button 812 is deletable. However, if the user is a general user, the group button is undeletable. That is, if the access right of the user who requests deletion is sufficiently high, and the button is deletable, the process advances to step S1203. Otherwise, the process advances to step S1204 to determine that the button is undeletable.

In step S1203, the button delete-capability determination unit 477 determines whether the deletion target button is currently in use. If in use, the process advances to step S1204 to determine that the button is undeletable. Otherwise, the process advances to step S1205 to determine that the button is deletable, and the processing ends. Note that although the group of the button data 501, user's authority, and button execution status are used as the determination conditions, any other conditions concerning deletion may be used.

As described above, in this embodiment, the button data 501 and the action data 510 can be deleted from the custom menu 470 while maintaining the consistency of the two data. This prevents any omission of deletion of the button data 501 and the action data 510. In addition, the user can delete a button not only for a native application 460 but also for a Web application 410 from the MFP 101 at an arbitrary timing.

### Third Embodiment

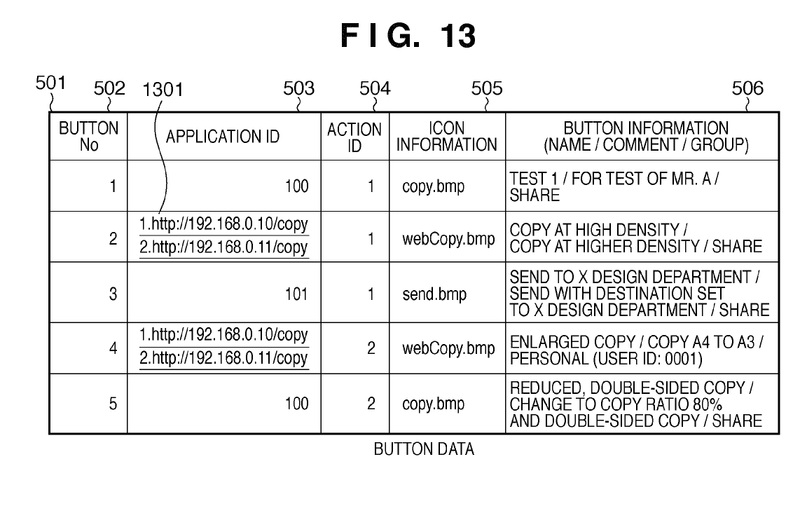

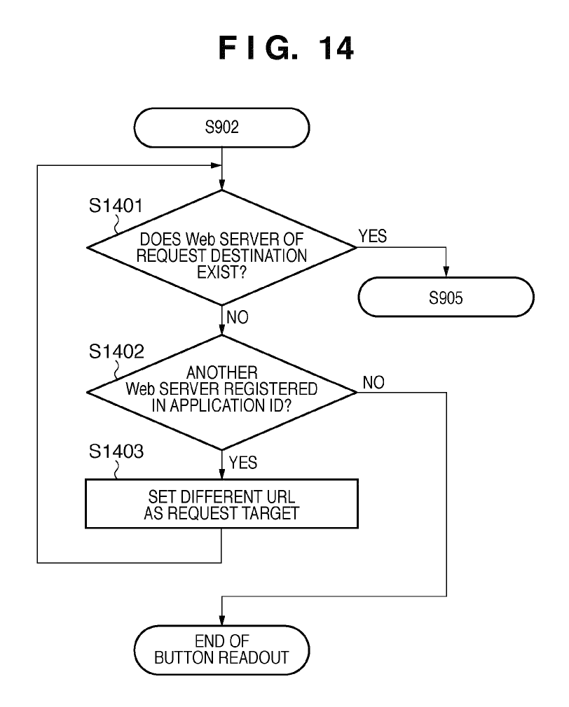

The third embodiment of the present invention will be described below with reference to FIGS. 13 and 14. In this embodiment, a series of processes to be executed when a button at which a plurality of application IDs 503 are registered is pressed on the operation screen of a custom menu 470 of an MFP 101 will be explained. Note that the overall arrangement of an information processing system 100 according to the embodiment, the arrangement of the MFP 101, the arrangement of a Web server 103, the control arrangement of the entire information processing system 100, the structure of button data 501, and the structure of action data 510 are the same as in the first embodiment, and a description thereof will not be repeated.

FIG. 13 is shows an example of the button data 501 in which a plurality of values are registered in the application ID 503. As shown in FIG. 13, “http://192.168.0.10/copy” and “http://192.168.0.11/copy” are assigned to an application ID 1301 corresponding to a button No 502 of “2”. That is, it is possible to register a plurality of values in the application ID 503.

Processing inserted between steps S902 and S905 described in FIG. 9 will be explained next with reference to FIG. 14. FIG. 14 illustrates Web server search processing to be executed when a plurality of values are set in the application ID 503 of the button data 501. The processing to be described below is implemented by causing a CPU 211 of the MFP 101 to read out a program stored in a ROM 212 or HDD 214 to a RAM 213 and execute the program.

In step S1401, a set operation screen request unit 483 of a CMSP 480 determines, based on the result of a set operation screen request in step S902, whether the Web server of request destination exists. If the Web server of request destination exists, the process advances to step S905. On the other hand, if the Web server of request destination does not exist, the process advances to step S1402. In step S1402, the set operation screen request unit 483 determines whether another Web server is registered in the application ID 503. If YES in step S1402, the process advances to step S1403. Otherwise, the processing ends because the set operation screen cannot be obtained from the Web server. In step S1403, the set operation screen request unit 483 defines an unrequested one of the Web servers registered in the application ID 503 as the request target, and returns the process to step S902.

As described above, when a plurality of Web servers are registered in the application ID of the button data 501, the request target can be changed to a communicable server apparatus in accordance with the current situation of the Web servers. Even when the Web server 103 is unusable because of a failure or maintenance, for example, a Web server 104 having the same Web application can be requested to execute processing on behalf of the Web server 103. This implements improvement of user convenience, and thus implements improvement of services along with an increase in the operating ratio.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-283435 filed on Dec. 14, 2009, which is hereby incorporated by reference herein in its entirety.

1. An information processing system including a server apparatus and an information processing apparatus capable of using an external application provided by the server apparatus, characterized in that
the information processing apparatus comprises:
first display control means for displaying, on a display unit, an operation screen of the external application including a registration button configured to register, in a custom menu, a custom button that causes a currently running application to execute processing based on current setting information;
first notification means for, when the registration button is pressed, notifying the server apparatus of a registration request of action data concerning the current setting information together with the current setting information;
button data storage means for, upon receiving a response to the registration request from the server apparatus, storing button data concerning the custom button using the action data added to the response; and
second display control means for, upon receiving an instruction to display the custom menu, reading out the button data from the button data storage means, generating the custom menu including the custom button corresponding to the readout button data, and displaying the custom menu on the display unit, and
the server apparatus comprises:
action data storage means for, upon receiving the registration request of the action data, storing the received current setting information as the action data; and
second notification means for notifying the information processing apparatus of a registration request of the button data together with the stored action data.

2. The system according to claim 1, characterized in that
the information processing apparatus further comprises request means for, when the custom button associated with the external application displayed on the custom menu is pressed, requesting the server apparatus to provide screen information using the button data corresponding to the custom button,
the server apparatus further comprises sending means for reading out action data corresponding to the request of the request means from the action data storage means, generating the screen information using the readout action data, and sending the screen information to the information processing apparatus, and
the first display control means displays, on the display unit using the screen information provided by the server apparatus, the operation screen of the external application in which setting information set upon pressing the registration button is set.

3. The system according to claim 1, characterized in that
the information processing apparatus further comprises:
third display control means for displaying the custom button registered in the custom menu to be selectable and displaying, on the display unit, a deletion button configured to delete the selected custom button;
third notification means for, when the deletion button is pressed while selecting the custom button associated with the external application, notifying the server apparatus of a deletion request of the action data corresponding to the selected custom button; and
first deletion means for, upon receiving information representing that deletion of the action data has normally been done from the server apparatus as a response to the deletion request, deleting the button data corresponding to the deleted action data, and
the server apparatus further comprises:
second deletion means for, upon receiving the deletion request, deleting the corresponding action data; and
fourth notification means for notifying the information processing apparatus of a deletion result by the second deletion means.

4. The system according to claim 3, characterized in that the information processing apparatus further comprises means for, when a user who has pressed the deletion button has authority to delete the custom button, and the custom button is not in use, instructing to delete the corresponding action data and button data.

5. The system according to claim 2, characterized in that
one button data is associated with information of a plurality of server apparatuses, and
the request means requests, out of the plurality of server apparatuses, a server apparatus capable of communicating with the information processing apparatus in a current situation to provide the screen information.

6. A method of controlling an information processing system including a server apparatus and an information processing apparatus capable of using an external application provided by the server apparatus,
characterized in that
the information processing apparatus executes:
causing first display control means to display, on a display unit, an operation screen of the external application including a registration button configured to register, in a custom menu, a custom button that causes a currently running application to execute processing based on current setting information;
causing first notification means to, when the registration button is pressed, notify the server apparatus of a registration request of action data concerning the current setting information together with the current setting information;
causing button data storage means to, upon receiving a response to the registration request from the server apparatus, store button data concerning the custom button using the action data added to the response; and
causing second display control means to, upon receiving an instruction to display the custom menu, read out the button data from the button data storage means, generate the custom menu including the custom button corresponding to the readout button data, and display the custom menu on the display unit, and
the server apparatus executes:
causing action data storage means to, upon receiving the registration request of the action data, store the received current setting information as the action data; and
causing second notification means to notify the information processing apparatus of a registration request of the button data together with the stored action data.

7. A computer-readable storage medium storing a computer program which causes a computer to execute an information processing apparatus control method of claim 6.
